(19) United States
(12) Patent Application Publication
(10) Pub. No.: US 2023/0144178 A1
(43) Pub. Date: May 11, 2023

(54) Automomously reporting plumbing mesh network applications

(71) Applicant: Peter Atwal, Longwood, FL (US)

(72) Inventor: Peter Atwal, Longwood, FL (US)

(21) Appl. No.: 17/519,792

(22) Filed: Nov. 5, 2021

(51) Int. Cl. G01M 3/24; G05B 23/02; G01M 3/28

(52) U.S. Cl. CPC G01M 3/24; G05B 23/0283; G01M 3/2815; G01M 3/2846; G01M 3/2853; G01M 3/2876; H04W 4/38

(57) ABSTRACT

The present disclosure relates to methods and systems for water damage protection and reporting associated with leak detection, usage monitoring, predictive maintenance and analytics related to plumbing infrastructure in free standing locations, buildings, homes, venues, manufacturing facilities, public infrastructure, restaurants and malls.

### FIELD

Embodiments of the disclosure are directed to solutions associated with water damage protection including water usage monitoring, leak detection, predictive maintenance and analytics in free standing locations, buildings, homes, venues, manufacturing facilities, public infrastructure, restaurants and malls.

### BACKGROUND

Current plumbing infrastructure including pipes, sewer systems, septic tanks, toilets, showers, bathrooms, water and sewage carrying systems, and pipes are generally not monitored except for certain pump components and water reporting systems that report equipment failure via sirens and physical audible alarms.

There are 3rd party reporting systems that can be configured with central water flow reporting apparatus that will send failure reports via specifically installed and configured wi-fi enabled software and equipment, but these systems require direct wire connection or direct contact with each reporting component or system element. These systems cannot support distributed wireless sensor reporting components inside walls, underground, in sewer caps, in clean-out caps, attached to or inside pipes or shut-off valves.

These 3rd party reporting solutions cannot accurately report or detect water leakage, micro leaks, worn parts, part usage, water usage, intermittent operational problems, poorly operating components, potential component failures and failure timelines. Mostly, such systems monitor water usage through user behavior algorithms and report unusual patterns of usage leading to high incidences of false positives i.e., reporting a leak when there isn't one or false negatives i.e., not reporting a leak when there is one.

### SUMMARY OF THE DISCLOSURE

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Further, when a particular feature, structure, or characteristic is described in connection with an embodiment, it is submitted that it is within the knowledge of one skilled in the art to implement such feature, structure, or characteristic in connection with other embodiments whether or not explicitly described.

The water damage protection system is a plumbing mesh network which is able to monitor and report on any plumbing infrastructure without direct contact or immersion in the infrastructure itself. The mesh network is comprised of sensors that peer with each other and exchange information, and applications that run either in the cloud, locally or on the sensor nodes that communicate in real-time to trap water events and usage.

The solution is quick, inexpensive and does not require skilled plumbing installation or labor to set up.

The system allows for reporting and emergency alarming to specific users, specified entities and building owners in real-time.

The solution is transparent to any network interconnect and is designed for virtual operation via cloud based processing where applications are transportable between clouds e.g. AWS, Azure, AT&T, etc. To get to the cloud it will interconnect via a Wi-Fi gateway which can connect to any or all sensor nodes. Therefore the dwelling unit at a minimum must support one WiFi Access Point (AP) to which a PlumMate sensor node without the sensor itself is interconnected physically via RJ-45 or via Wi-Fi, Zigbee or BlueTooth. The system operates such that the PlumMate proprietary mesh protocol runs throughout the building or premises, and the other side is connected with the AP thru a standard interconnect.

Embodiments described herein provide methods and systems for building a new autonomously reporting mesh network for plumbing systems and infrastructure, where the network uses a mesh concept of peer-to-peer sensors and components, and ties into a backend server system that hosts applications for performing alarming, reporting and predictive analytics.

The plumbing mesh network uses a wireless sensor network that allows for on-site network construction to be ad hoc and free form allowing sensors to be installed without regard to location such that communications and data are passed peer-to-peer in a non-blocking architecture and allowing for fail-proof connectivity in all environments and locations.

The predictive analytics use algorithms specifically developed to detect long term trends within a plumbing mesh reporting network that is continuously monitoring and reporting on water leakage, micro leaks, worn parts, water usage, intermittent operational problems, poorly operating components, potential component failures and tracking failure timelines.

A depiction of the plumbing mesh reporting system, and potential location of the reporting sensors and chips is shown in the Drawings as FIG. 1.

In some embodiments the plumbing mesh reporting system may be local only meaning that it is not connected to an Internet and serves a local functionality only for the on-premises support personnel e.g., supervisory staff in an office building.

In some other embodiments the plumbing mesh reporting system is self-contained meaning that it is not connected to an Internet nor a local connection server. Instead the system reports only when triggered by field personnel using wireless devices for one-time data collection. The sensor reports are held on chip until the data is gathered and then reset or released by the field personnel.

Additional embodiments can include a “remote” plumbing mesh reporting system which is not connected to the Internet due its remote location where there is a lack of communications infrastructure. In this case, the system is tied to a satellite network through a satellite gateway provider. Data is preprocessed at the gateway, prior to transmit to reduce redundant data information and to streamline reporting over the more expensive satellite connections. The sensor reports are held on chip until the data is gathered by the satellite gateway reporting system and then reset.

The terms “local”, “remote”, “connection” and “self-contained”, along with their derivatives, may be used at any point in this specification document. “Connection” is used to indicate the establishment of communication between two or more elements that are part of the plumbing mesh reporting network.

A sensor, gateway, access point, base station or hub is an electronic device (e.g., a sensor node, end station, a network device) which stores and transmits (internally and/or with other electronic devices over a network) data to local servers or external communications networks.

A network device or apparatus (e.g., a router, switch, bridge) is a piece of networking equipment, including hardware and software, which interconnects other equipment on the network (e.g., other network devices, end stations).

While processes in the figures may show a particular order of operations performed by certain embodiments of the invention, it should be understood that such order is exemplary (e.g., alternative embodiments may perform the operations in a different order, combine certain operations, overlap certain operations, etc.)

### BRIEF DESCRIPTION OF THE DRAWINGS

FIG. 1 shows a basic data flow of the end-to-end process and how the application and sensor nodes cooperate to collect, report, alarm, store and process the data.

FIG. 2 shows a typical sensor node and the components that are key to the sensor.

FIG. 3 shows how signaling is used to allocate water to a target usage based on the plumbing fixture type and based on preset or dynamic controls. Note: vibration sensors sense the fixture and will continue to demand water until the fixture is turned off.

FIG. 4 shows how leak detection is performed using the sensor network's capabilities for time-division-of-arrival (TDoA) algorithms and triangulation to pinpoint the leak location to the nearest fixture.

FIG. 5-1 thru 5-4 show the main Cloud elements and reporting elements used to drive predictive analytics, maintenance programs, user reporting functions, etc.

### DETAILED DESCRIPTION OF THE DRAWINGS

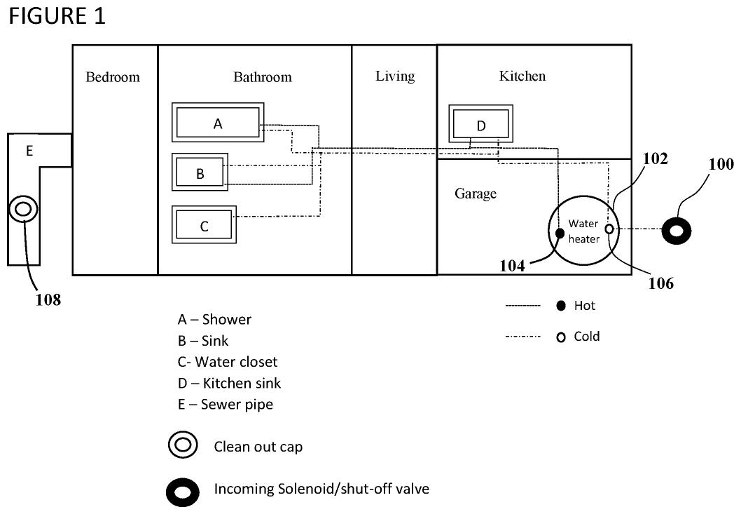

FIG. 1 shows the basic flow of water in a premises. This can be extrapolated to multi-dwelling units. The flow depicts the relationship between the cold water source from the street (100) and how it flows to the plumbing apparatus and fixtures e.g. hot water heater (102), and from there how the cold (104) and hot (106) sources flow to other areas of the dwelling and finally out to the sewer (108). It also shows the relationship between the shut off valve (100) and the sewer (108) where the clean out cap is installed. The key to the PlumMate system is to avoid a single point of decision or failure, and to provide multiple feedback loops at all times for leak detection, pinpointing leak location, gathering usage and event statistics at all points of presence where there is infrastructure that requires monitoring or could fail.

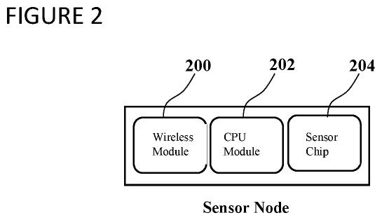

FIG. 2 shows the sensor node. It shows the three (3) key components, viz. the wireless communications module (200) based on a proprietary technology that uses unlicensed band spectrum, a processing unit (202) that houses the software and applications code, and the sensor itself (204) which will be either an acoustic sensor or a vibration sensor depending on the fixture requirements. These requirements are fixture specific.

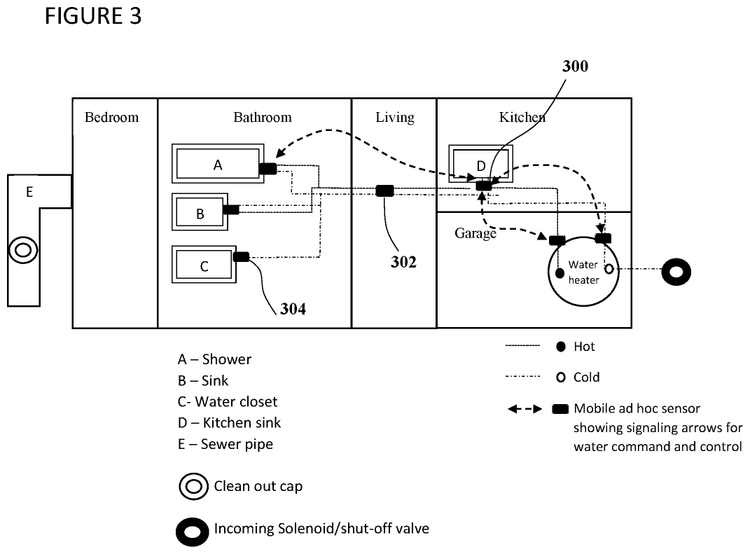

FIG. 3 shows how PlumMate dynamic signaling works. PlumMate does not rely on “time of day” algorithms nor does it rely on “learned behavior” algorithms that take time to settle based on the usage patterns of the dwelling occupants. Instead each fixture must request its water or activate the fixture, where vibration (300) or acoustics (302) are used to trigger the water request. Each sensor has either an acoustic sensor unit or a vibration sensor unit depending upon the plumbing fixture it is attached to. Acoustic sensors are suitable for “listening” to running water noise whereas vibration sensors are more suited to plumbing units like the showers, toilets or sinks where the act of turning on a tap or flushing releases water pressure and the vibration triggers the sensors. In addition, the vibration sensors can be unit specific. As an example in FIG. 3 the vibration sensor (304) for the water closet is different to the sensor for the kitchen sink (300) and as such they can request water in discrete amounts. For example, the water closet requests 1.6 gallons per flush, whereas the kitchen sink could be set for unlimited or time bound usage.

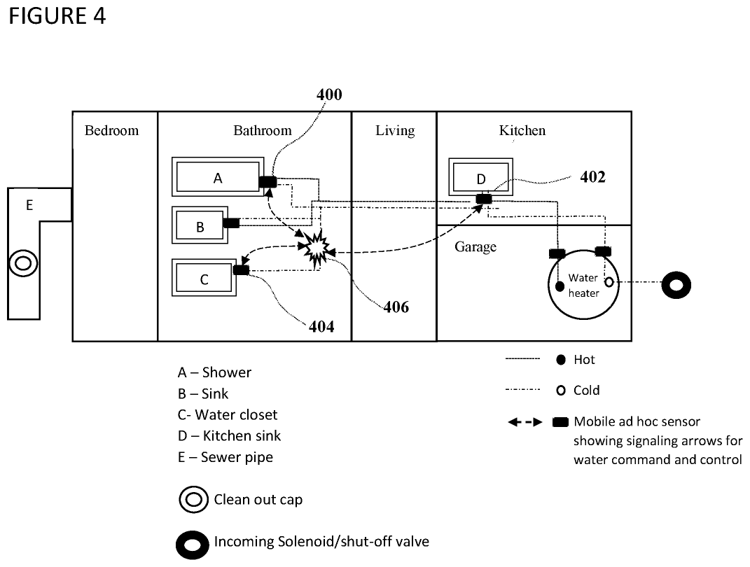

FIG. 4 shows the methodology whereby leaks are pinpointed. In this depiction, using the unique features of the wireless module which supports a TDMA (time division multi-plex access) architecture therefore each sensor around the leak (406) is able to report the time at which a flow occurred or when a flow was interrupted by a leak. Using triangulation between the sensors and geo-coordination based on time division of arrival (TDoA) the sensors and system are able to pinpoint the leak. In the depiction, sensors (400), (402) and (404) are able to triangulate relative position with each other, and then using TDoA report on the leak position at (406). This helps direct the plumber to the location of the leak without causing undue property damage.

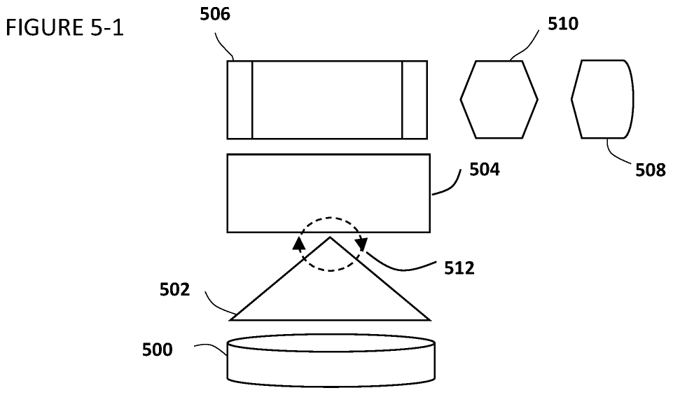

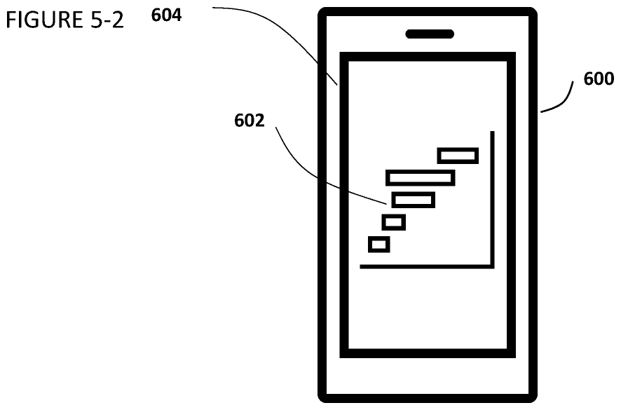

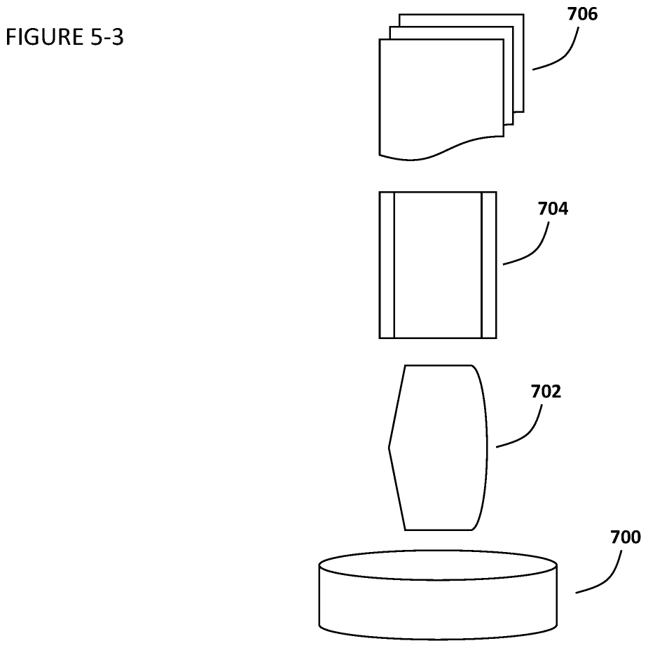

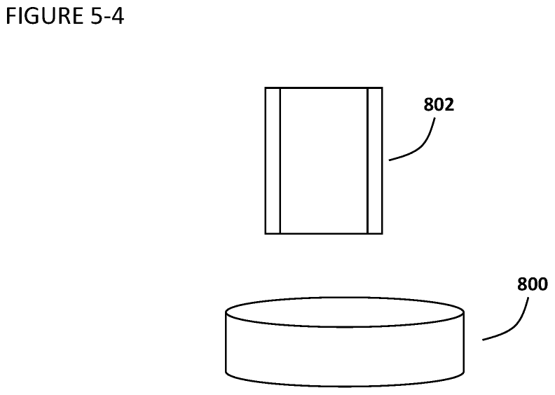

In embodiments, the methods, systems, kits and apparatuses for the PlumMate application can include any type of data collection which would be customized to the target application. FIG. 5-1, shows a standard data analytics flow where a data lake (500) or infrastructure-less database is used to store the gathered PlumMate data from the sensor nodes. The data lake can ingest the data for real-time, non-real-time or offline for long term trend analysis. During the ingestion process the gathered or collected data may be combined with other datasets (public or non-public) such as weather, location, parts history, etc. to further inform long-term trend analysis. Then extraction, transform and load (ETL) operations take place (502) based on the needs of the specific PlumMate applications. The systems allows for multiple and concurrent ETL cycles (512) based on the PlumMate application e.g., local, national, targeted information, etc based on the number of insights being derived for each of the cycles. As each cycle completes an application specific process (504) executes that is designed to pull certain types of information based on specific algorithms (506) to a user level in preparation (510) for display (508) to a cell phone or PC.

In embodiments, the method, Systems, kits and apparatuses used to provide the PlumMate application user interface can include any interface such as a cell phone (600) or PC that is intuitive to use and only requires the user to interact with the cell phone screen or PC. FIG. 5-2 shows the basic menu where the user uses a finger or thumb to trace the screen and to pick out the application options on the user screen (602). Each target application (604) will have its own options and report types. These screens will be built in response to generic and specific 3rd party requests for data intelligence.

In embodiments, the methods, systems, kits and apparatuses used to provide the PlumMate data collection and processing results to the marketeer or 3^{rd} party service provider are arranged in specific datasets for transmission and dissemination. In FIG. 5-3, various methods are shown for how these results are provided including allowing for access to protected external storage devices, data warehouses or storage farms (700), data access via controlled browsing screens (702), via data interchange over the Internet (704) or via manual reports (706).

In embodiments, the methods, systems, kits and apparatuses used to provide the cloud storage and processing elements are organized such that all resources dedicated to data collection and reporting can grow exponentially by taking advantage of the Cloud's elasticity for data storage and compute power. FIG. 5-4 shows the main cloud elements that drive fees for data access, running proprietary algorithms or data runs. Viz. 3rd party customers would pay fees based on the consumption of the amount of storage (800) and compute power (802), and on the amount of time that the data is kept for that 3^{rd} party payor. If multiple 3^{rd} parties want the same data each will be apportioned their fees based on their consumption patterns and long-term storage needs.

What is claimed:

1. A method, comprising:
Processing, gathering and transferring plumbing data at a sensor node from a transmitter to a receiver;
Using an ad-hoc mobile communications peer-to-peer network to link all sensor nodes within a discrete plumbing network such that nodes can interact with each other directly or via hopping or meshing to assure all nodes are actively reporting and interconnected with each other;
Running plumbing specific applications such as leak detection using attributes of the peer-to-peer mesh such that wireless triangulation based on time division of arrival (TDoA) and geo-coordination provides pin-point accuracy in real-time;
Running plumbing specific applications using the attributes of the peer-to-peer mesh such that sensor based vibration and sensor based acoustics can be used to drive in-network signaling from a fixture requiring water to the master solenoid to release water to the target fixture;
Determining that all nodes in the ad hoc network are connected via run-time sensor node analysis wherein each sensor node provides its identifier and data to a reporting system or application for a system wide check; and
Using the Internet or a local area network or a mobile hand held peer to peer communications device to extract sensor data for a local area plumbing network for leak detection reporting and alarming, water usage data, maintenance data for predictive analytics and user data analysis.

2. A system of claim 1 whereby:
A computer program product comprising computer executable code stored in a non-transitory computer readable medium that, when executing on one or more computing devices, determines plumbing health of a local area plumbing network wherein the plumbing network covers free standing locations, buildings, homes, venues, manufacturing facilities, public infrastructure, restaurants and malls by performing the steps of:
Data collection from all the sensor nodes on a periodic or real-time basis;
Checking for pressure variances and set-point violations;
Processing signaling requests from sensors attached to plumbing fixtures to release water to said fixture based on a time duration, program variable or sensors with dynamic signaling capability e.g. vibration sensors or acoustics sensors;
Processing alarms based on sensor reports for leaks;
Processing alarm information to pin-point the pipes or fixtures with leaks using triangulation, pressure variances, signaling data, usage data and TDoA (time division of arrival) measurements;
Processing time series information used for predictive analytics using maintenance reports, usage reports, leak reports, pressure reports, etc.; and
Providing reports to 3^{rd} parties including users, owners, entities, insurance companies, etc.

3. A system of claim 1 whereby:
A sensor node that supports a peer-to-peer mesh network capable of TDoA and geo coordination with its neighbors for leak detection, and that supports sensor application processing and master solenoid signaling for requesting water and releasing water based on time of day, vibration or acoustic inputs from a plumbing fixture.

4. A system of claim 1 whereby:
The plumbing network supports ad hoc access using drive-up or handheld device access, on demand, based on authorization and authentication of the on-demand device.

5. A system of claim 4 whereby:
An on-demand device that connects ad hoc to the network can ascertain the plumbing network map and the relative position of the sensors and the clean out cap to save plumber time and damage from occurring.
